(19) United States
(12) Patent Application Publication
(10) Pub. No.: US 2026/0074227 A1
(43) Pub. Date: Mar. 12, 2026

(54) ELECTRODE FOR SECONDARY BATTERY AND SECONDARY BATTERY INCLUDING THE SAME

(71) Applicant: SK ON CO., LTD., Seoul (KR)

(72) Inventors: Ui Jin CHOE, Daejeon (KR); Mi Sook KWON, Daejeon (KR)

(21) Appl. No.: 19/318,367

(22) Filed: Sep. 4, 2025

(30) Foreign Application Priority Data
Sep. 10, 2024 (KR) 10-2024-0123551

(51) Int. Cl. H01M 4/62; H01M 10/052; H01M 10/0562

(52) U.S. Cl. CPC H01M 4/623; H01M 10/052; H01M 10/0562; H01M 2300/0068

(57) ABSTRACT

The present disclosure relates to an electrode for a secondary battery and a secondary battery including the electrode. According to embodiments of the present disclosure, the electrode for a secondary battery includes: an electrode current collector, a first electrode active material layer disposed on the electrode current collector, and including a first electrode active material, a first binder including a fluorine-based binder and a first solid electrolyte; and a second electrode active material layer disposed on the first electrode active material layer, and including a second electrode active material, a second binder including a hydrocarbon-based binder and a second solid electrolyte.

### CROSS REFERENCE TO RELATED APPLICATIONS

The present application claims priority under 35 U.S.C. § 119 (a) to Korean Patent Application No. 10-2024-0123551 filed on Sep. 10, 2024, which is incorporated herein by reference in its entirety BACKGROUND

### 1. FIELD OF THE INVENTION

The present disclosure relates to an electrode for a secondary battery and a secondary battery including the electrode.

### 2. DESCRIPTION OF THE RELATED ART

Secondary batteries are batteries that can be repeatedly charged and discharged. With the development of information and communication and display industries, the secondary batteries have been widely applied as power sources for portable electronic communication devices, such as camcorders, mobile phones, and laptop PCs. In addition, battery packs including the secondary batteries have recently been developed and applied as power sources for eco-friendly vehicles, such as hybrid cars.

Examples of the secondary battery include a lithium secondary battery, a nickel-cadmium battery, and a nickel-hydrogen battery. Among these, the lithium secondary battery has a high operating voltage, high energy density per unit weight, and advantages in fast charging and lightweight design.

The lithium secondary battery may include a liquid electrolyte as the electrolyte. When a liquid electrolyte is used, safety issues such as leakage, explosion, and ignition may occur due to sudden environmental changes, including temperature fluctuations, external impacts and the like. Accordingly, solid-state batteries including electrolytes in gel or solid form are being developed to enhance stability. For example, an all-solid-state battery, which includes a completely solid electrolyte, may be provided as a type of solid-state battery.

The solid-state battery may include an electrode assembly including a cathode, an anode and an electrolyte layer. The cathode, anode and/or electrolyte layer of the solid-state battery may include a solid electrolyte. As the application range of solid-state batteries continues to expand, a longer lifespan, higher capacity, and greater energy density are increasingly required.

### SUMMARY

An object of the present disclosure is to provide an electrode for a secondary battery with improved energy density and output characteristics.

Another object of the present disclosure is to provide a secondary battery with improved capacity and output characteristics.

To achieve the above objects, according to an aspect of the present disclosure, there is provided an electrode for a secondary battery including: an electrode current collector, a first electrode active material layer disposed on the electrode current collector, and including a first electrode active material, a first conductive material, a first binder including a fluorine-based binder and a first solid electrolyte; and a second electrode active material layer disposed on the first electrode active material layer, and including a second electrode active material, a second conductive material, a second binder including a hydrocarbon-based binder and a second solid electrolyte.

In some embodiments, the fluorine-based binder may include at least one of a vinylidene fluoride-based polymer and a vinylidene fluoride-hexafluoropropylene copolymer.

In some embodiments, the hydrocarbon-based binder may include a butadiene-based rubber.

In some embodiments, the hydrocarbon-based binder may have a non-aromatic structure.

In some embodiments, the content of the first binder in the first electrode active material layer and the content of the second binder in the second electrode active material layer may differ from each other.

In some embodiments, the content of the first binder in the first electrode active material layer may be greater than that of the second binder in the second electrode active material layer.

In some embodiments, a ratio of the content of the second binder in the second electrode active material layer to the content of the first binder in the first electrode active material layer may be 0.1 or more and less than 1.

In some embodiments, the content of the first binder may be greater than 0.1 wt % and less than or equal to 20 wt % based on the total weight of the first electrode active material layer, and the content of the second binder may be 0.1 wt % to 10 wt % based on the total weight of the second electrode active material layer.

In some embodiments, the content of the first conductive material in the first electrode active material layer and the content of the second conductive material in the second electrode active material layer may differ from each other.

In some embodiments, the content of the second conductive material in the second electrode active material layer may be greater than that of the first conductive material in the first electrode active material layer.

In some embodiments, the ratio of the content of the second conductive material in the second electrode active material layer to the content of the first conductive material in the first electrode active material layer may be greater than 1 and less than or equal to 5.

In some embodiments, the content of the first conductive material may be 0.1 wt % to 10 wt % based on the total weight of the first electrode active material layer, and the content of the second conductive material may be more than 0.1 wt % and less than 20 wt % based on the total weight of the second electrode active material layer.

In some embodiments, the ratio of the content of the second solid electrolyte in the second electrode active material layer to the content of the first solid electrolyte in the first electrode active material layer may be 0.1 to 1.0.

In some embodiments, the first solid electrolyte and the second solid electrolyte each include a sulfide-based electrolyte.

In some embodiments, the ratio of the content of the second electrode active material in the second electrode active material layer to the content of the first electrode active material in the first electrode active material layer may be 0.95 to 1.05.

According to another aspect of the present disclosure, there is provided a secondary battery including: the above-described electrode for a secondary battery; a counter electrode disposed to face the electrode for a secondary battery; and an electrolyte layer interposed between the electrode for a secondary battery and the counter electrode.

In some embodiments, the electrolyte layer may include a solid electrolyte.

In some embodiments, the secondary battery may be provided as an all-solid-state battery.

The electrode for a secondary battery according to the embodiments of the present disclosure may have improved electronic conductivity, with an electronically conductive network uniformly formed therein.

The secondary battery according to the embodiments of the present disclosure may exhibit improved rate characteristics.

The lithium secondary battery according to the embodiments of the present disclosure may be widely applied in green technology fields, such as electric vehicles, battery charging stations, as well as solar power generation, wind power generation, and the like, which use the batteries. In addition, the lithium secondary battery according to the embodiments of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating an electrode for a secondary battery according to exemplary embodiments; and

FIG. 2 is a schematic cross-sectional view illustrating an electrode cell according to exemplary embodiments.

### DETAILED DESCRIPTION

According to embodiments of the present disclosure, an electrode for a secondary battery including a solid electrolyte, and a secondary battery including the electrode are provided.

Hereinafter, the embodiments of the present disclosure will be described in more detail with reference to the accompanying drawings. However, the drawings attached to the present disclosure are merely illustrative of some embodiments of the present disclosure to aid in understanding the technical spirit of the invention together with the foregoing description. Therefore, the present disclosure should not be construed as being limited to the matters illustrated in the drawings.

The terms “upper portion,” “lower portion,” “upper surface,” “lower surface,” “first,” “second,” etc. as used herein indicate relative positions of respective components and do not imply absolute positional relationships.

Hereinafter, unless otherwise defined in the present specification, when a portion such as a layer, film, thin film, region, or plate is described as being “on” or “above” another portion, it may refer not only to a case where the portion is directly on the other portion, but also to a case where another portion is interposed therebetween.

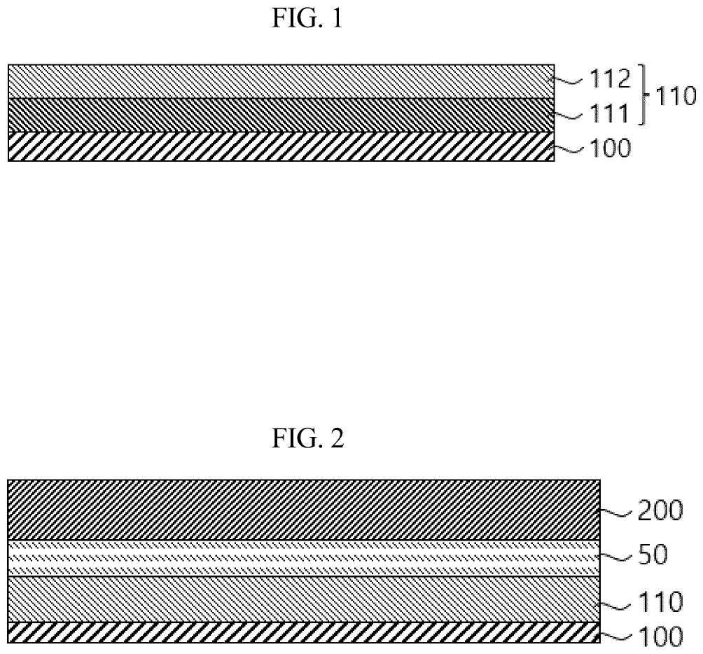

FIG. 1 is a schematic cross-sectional view illustrating an electrode for a secondary battery according to exemplary embodiments.

Referring to FIG. 1, the electrode for a secondary battery may include an electrode current collector 100 and an electrode active material layer 110 formed on the electrode current collector 100. The electrode active material layer 110 may be formed on both surfaces (e.g., upper and lower surfaces) of the electrode current collector 100.

The electrode active material layer 110 may include a plurality of active material layers sequentially disposed on the electrode current collector 100.

According to exemplary embodiments, the electrode active material layer 110 may include a first electrode active material layer 111 disposed on the electrode current collector 100 and a second electrode active material layer 112 disposed on the first electrode active material layer 111.

The first electrode active material layer 111 and the second electrode active material layer 112 may each include an electrode active material, a conductive material, and/or a binder.

The first electrode active material layer 111 may include a first electrode active material, a first conductive material and a first binder. The second electrode active material layer 112 may include a second electrode active material, a second conductive material and a second binder.

According to exemplary embodiments, the content of the first conductive material in the first electrode active material layer 111 and the content of the second conductive material in the second electrode active material layer 112 may differ from each other.

The term “content of”b in A” or “concentration of b in A” as used herein, may refer to the weight percent (%) of b included in A based on the total weight of A.

The concentration of the conductive material may increase with increasing distance from the electrode current collector 100. For example, the content of the second conductive material in the second electrode active material layer 112 may be greater than that of the first conductive material in the first electrode active material layer 111.

Since the second electrode active material layer 112 includes a relatively high content of the conductive material, the electronic conductivity of the second electrode active material layer 112 may be supplemented even when it is positioned relatively far from the electrode current collector 100. Accordingly, a conductive network may be uniformly formed in both the upper and lower portions of the electrode active material layer 110, thereby improving the electronic conductivity of the electrode active material layer 110 and the output characteristics of the lithium secondary battery.

In some embodiments, the ratio of the content of the second conductive material in the second electrode active material layer 112 to the content of the first conductive material in the first electrode active material layer 111 may be greater than 1 and less than or equal to 5. For example, the concentration ratio of the conductive materials may be greater than 1 and less than or equal to 3, 1.1 to 2.5, or 1.2 to 2. Within the above range, the electronic conductivity of the electrode active material layer 110 may become uniform throughout, and the capacity and output may be further improved.

In some embodiments, the content of the first conductive material may be about 0.1% by weight (“wt %”) to 10 wt % based on the total weight of the first electrode active material layer 111. Within the above range, electron migration between the electrode active materials may be further promoted, and since the conductive material is not included in an excessive amount, the capacity of the secondary battery may be further increased.

In one embodiment, the content of the first conductive material may be about 0.1 wt % to 5 wt %, about 0.1 wt % to 3 wt %, or about 0.5 wt % to 2 wt % based on the total weight of the first electrode active material layer 111.

In some embodiments, the content of the second conductive material may be greater than about 0.1 wt % and less than or equal to 20 wt % based on the total weight of the second electrode active material layer 112. Within the above range, a conductive network may be formed more densely in the upper portion of the electrode active material layer 110, and the diffusion resistance within the electrode active material layer 110 may be further reduced.

In one embodiment, the content of the second conductive material may be greater than about 0.1 wt % and less than or equal to 10 wt %, greater than about 0.1 wt % and less than or equal to 5 wt %, or about 0.5 wt % to 3 wt % based on the total weight of the second electrode active material layer 112.

The first electrode active material layer 111 and the second electrode active material layer 112 may include different types of binders. The first binder may include a non-aqueous binder, and the second binder may include a hydrocarbon-based binder.

According to exemplary embodiments, the non-aqueous binder may include a fluorine-based polymer.

The fluorine-based polymer may refer to a polymer in which at least some repeating units contain fluorine. The first electrode active material layer 111 may include a fluorine-based polymer as a binder, thereby increasing the ionic conductivity of the electrode active material layer 110.

Accordingly, the ionic conductivity of the first electrode active material layer 111 may be enhanced, and the ionic conductivity of the electrode active material layer 110 may be improved overall. In addition, since the first electrode active material layer 111 is in contact with the current collector, the overall oxidation stability of the first electrode active material layer 111, which requires a high oxidation potential, may be improved.

For example, the fluorine-based polymer may include polyvinylidene fluoride (PVdF), vinylidene fluoride-hexafluoropropylene copolymer (PVDF-co-HFP), polychlorotrifluoroethylene (PCTFE), or polytetrafluoroethylene (PTFE).

In some embodiments, the fluorine-based polymer may include a vinylidene fluoride (VdF)-based polymer containing a structural unit derived from vinylidene fluoride. For example, the non-aqueous binder may include PVdF and/or PVdF-co-HFP. The electrochemical stability and ionic conductivity of the first electrode active material layer 111 may be further improved by the PVdF-based polymer.

According to exemplary embodiments, the hydrocarbon-based binder may include a hydrocarbon-based polymer. The second binder may include the hydrocarbon-based polymer, thereby further improving the dispersibility of the second conductive material within the second electrode active material layer 112.

For example, as the content of the conductive material increases, the dispersibility may decrease due to agglomeration or assembly among the conductive materials. In this case, the conductive network in the second electrode active material layer 112 may be formed unevenly, thereby decreasing the electronic conductivity of the electrode active material layer 110.

According to exemplary embodiments, the second binder may include a hydrocarbon-based binder, thereby allowing the second conductive material to be uniformly distributed within the second electrode active material layer 112. Accordingly, the electronic conductivity of the electrode active material layer 110 may be improved.

In one embodiment, the hydrocarbon-based binder may include a butadiene-based polymer. The butadiene-based polymer may have high affinity for carbon-based materials and metal particles, thereby further enhancing the dispersibility of the conductive material. Accordingly, the internal resistance of the second electrode active material layer 112 may be reduced.

The butadiene-based polymer may include butadiene rubber (BR), nitrile-butadiene rubber (NBR), hydrogenated NBR (HNBR), styrene butadiene rubber (SBR) and the like. These may be used alone or in combination of two or more thereof.

In some embodiments, the hydrocarbon-based binder may have a non-aromatic structure. For example, the hydrocarbon-based polymer may not include an aromatic structure (e.g., a benzene ring, etc.).

Since the hydrocarbon-based binder has a non-aromatic structure, the dispersibility of the second conductive material may be further enhanced, and the electronic conductivity and structural stability of the second electrode active material layer 112 may be improved.

In one embodiment, the hydrocarbon-based binder may include butadiene rubber (BR) or nitrile-butadiene rubber (NBR), and preferably includes butadiene rubber.

According to exemplary embodiments, the binder concentration in a region adjacent to the electrode current collector 100 in the electrode active material layer 110 may be relatively high. For example, the content of the first binder in the first electrode active material layer 111 may be greater than that of the second binder in the second electrode active material layer 112.

Since the first binder may be included at a relatively high concentration in the first electrode active material layer 111, the adhesion between the electrode current collector 100 and the electrode active material layer 110 may be increased. In addition, the binder migration phenomenon may be suppressed, thereby improving the electrical and physical contact between the electrode active material layer 110 and the electrode current collector 100. Accordingly, peeling or detachment of the electrode active material layer 110 may be prevented, and the interfacial resistance between the electrode current collector 100 and the electrode active material layer 110 may be reduced.

According to exemplary embodiments, since the first binder includes a fluorine-based polymer, the ionic conductivity of the first electrode active material layer 111 may remain high even if the content of the first binder increases.

In some embodiments, the ratio of the content of the second binder in the second electrode active material layer 112 to the content of the first binder in the first electrode active material layer 111 may be greater than or equal to 0.1 and less than 1. For example, the concentration ratio of the binders may be greater than or equal to 0.2 and less than 1, 0.2 to 0.9, or 0.3 to 0.8. Within the above range, the adhesion between the electrode active material layer 110 and the electrode current collector 100 may be enhanced, thereby further improving the energy density and capacity.

In one embodiment, the content of the first binder may be greater than about 0.1 wt % and less than or equal to 20 wt % based on the total weight of the first electrode active material layer 111. Within the above range, the adhesion between the electrode current collector 100 and the electrode active material layer 110 may be further improved while preventing a decrease in energy density and capacity.

In one embodiment, the content of the first binder may be about 0.5 wt % to 10 wt %, about 0.5 wt % to 5 wt %, or about 1 wt % to 3 wt % based on the total weight of the first electrode active material layer 111.

In one embodiment, the content of the second binder may be about 0.1 wt % to 10 wt % based on the total weight of the second electrode active material layer 112. Within the above range, the capacity and output characteristics of the secondary battery may be improved.

In one embodiment, the content of the second binder may be about 0.1 wt % to 5 wt %, about 0.1 wt % to 3 wt %, or about 0.5 wt % to 2 wt % based on the total weight of the second electrode active material layer 112.

In some embodiments, the ratio of the content of the second electrode active material in the second electrode active material layer 112 to the content of the first electrode active material in the first electrode active material layer 111 may be 0.95 to 1.05.

For example, the electrode active material may have a uniform concentration distribution within the electrode active material layer 110. The content of the first electrode active material in the first electrode active material layer 111 and the content of the second electrode active material in the second electrode active material layer 112 may be substantially the same.

In one embodiment, the content of the first electrode active material may be about 60 wt % to 99 wt % based on the total weight of the first electrode active material layer 111. For example, the content of the first electrode active material may be about 70 wt % to 99 wt %, or about 80 wt % to 95 wt %.

In one embodiment, the content of the second electrode active material may be about 60 wt % to 99 wt % based on the total weight of the second electrode active material layer 112. For example, the content of the second electrode active material may be about 70 wt % to 99 wt %, or about 80 wt % to 95 wt %.

Each of the first electrode active material layer 111 and the second electrode active material layer 112 may further include a solid electrolyte. For example, the first electrode active material layer 111 may include a first solid electrolyte, and the second electrode active material layer 112 may include a second solid electrolyte. The ionic conductivity of the first electrode active material layer 111 and the second electrode active material layer 112 may be enhanced or supplemented by the solid electrolyte.

In some embodiments, the ratio of the content of the second solid electrolyte in the second electrode active material layer 112 to the content of the first solid electrolyte in the first electrode active material layer 111 may be 0.1 to 1.0.

Within the above range, a uniform ionic conduction pathway may be formed across the entire regions of the first electrode active material layer 111 and the second electrode active material layer 112. Accordingly, ion migration between the lower and upper surfaces of the electrode active material layer 110 may become more efficient, thereby further improving the capacity and output characteristics.

For example, the solid electrolyte may have a uniform concentration distribution within the electrode active material layer 110. The content of the first solid electrolyte in the first electrode active material layer 111 and the content of the second solid electrolyte in the second electrode active material layer 112 may be substantially the same.

In one embodiment, the content of the first solid electrolyte may be 3 wt % to 30 wt % based on the total weight of the first electrode active material layer 111. For example, the content of the first solid electrolyte may be 3 wt % to 25 wt %, or 5 wt % to 20 wt %.

In one embodiment, the content of the second solid electrolyte may be 3 wt % to 30 wt % based on the total weight of the second electrode active material layer 112. For example, the content of the second solid electrolyte may be 3 wt % to 25 wt %, or 5 wt % to 20 wt %.

In some embodiments, the first solid electrolyte and the second solid electrolyte may each include a sulfide-based electrolyte and/or an oxide-based electrolyte.

In some embodiments, the sulfide-based electrolyte may include a compound represented by Formula 1.

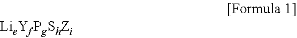

In Formula 1, e, f, g, h and i may satisfy 0<e<12, 0≤f≤6, 0≤g≤6, 0<h≤12, and 0≤j≤9, Y may be at least one element selected from the group consisting of B, Al, Ga, In, Si, Ge, Sn, Pb, As, Sb, Bi, Ti, V, Cr, Mn, Fe, Co, Ni, Cu, Y, Zr, Nb, Mo, Tc, Ru, Rh, Pd, Ag, Hf, Ta and W, and Z may be at least one element selected from the group consisting of F, Cl, Br and I.

In one embodiment, the sulfide-based electrolyte may be an LPS-based solid electrolyte including Li, P and S, an LGPS-based solid electrolyte including Li, P, Ge and S, or an LSiPSCl-based solid electrolyte including Li, Si, P, S and Cl.

For example, as the sulfide-based electrolyte, Li₂S—P₂S₅, Li₁₀GeP₂S₁₂, Li₁₀SnP₂S₁₂, Li_{9.54}Si_{1.74}P_{1.44}S_{11.7}Cl_{0.3}, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li₁₀GeP₂S_{11.7}O₀₃, Li_{9.6}P₃S₁₂, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li_{9.42}Si_{1.02}P_{2.1}S_{9.96}O_{2.04}, Li₆PS₅Cl, etc. may be used.

In one embodiment, the oxide-based electrolyte may include an ion-conductive compound containing a metal oxide and/or oxygen.

Examples of the metal oxide may include Al₂O₃, ZnO₂, Ce₂O₃, TiO₂, ZrO₂, HfO₂, MnO₂, MgO, WO₂, V₂O₅, etc.

Examples of the ion-conductive compound may include garnet compounds such as LLZO compounds; perovskite compounds such as LLTO compounds; NASICON compounds such as Li_{1+z}AlₓGe₂₋ₓ(PO₄)₃(0<x<2), Li₁₊ₓAlₓTi₂₋ₓ(PO₄)₃(0<x<2), Li₁₊ₓTi_{2-x-y}AlₓSi_{y}(PO₄)_{3-y}(0≤x≤1, (<y≤1), LAGP compounds, LATP compounds, LiAlₓZr₂₋ₓ(PO₄)₃(0≤x≤1), LiTiₓZr₂₋ₓ(PO₄)₃(0≤x≤1); LIPON compounds; Li₆La₂CaTa₂O₁₂; Li₆La₂ANb₂O₁₂ (where A is Ca or Sr); Li₂Nd₃TeSbO₁₂, Li₃BO_{2.5}N_{0.5}; Li₉SiAlO₈, etc.

In some embodiments, the first solid electrolyte and the second solid electrolyte may be formed of the same type of compound. In some embodiments, the first solid electrolyte and the second solid electrolyte may include different types of compounds.

In some embodiments, the loading amount of the first electrode active material layer 111 and the loading amount of the second electrode active material layer 112 may be substantially the same. In some embodiments, the loading amount of the first electrode active material layer 111 and the loading amount of the second electrode active material layer 112 may differ from each other.

For example, the loading amount of the first electrode active material layer 111 and the loading amount of the second electrode active material layer 112 may each be 0.1 mAh/cm² to 6.0 mAh/cm².

For example, the first electrode active material layer 111 and the thickness of the second electrode active material layer 112 may each have a thickness of 1 μm to 200 μm. In one embodiment, the thickness of the first electrode active material layer 111 and the thickness of the second electrode active material layer 112 may be the same or different from each other.

According to exemplary embodiments, the first electrode active material layer 111 and the second electrode active material layer 112 may be formed by sequential coating.

The first electrode active material layer 111 may be formed by coating a first electrode slurry on the electrode current collector 100. The second electrode active material layer 112 may be formed by coating a second electrode slurry on the first electrode active material layer 111.

In one embodiment, the second electrode active material layer 112 may be formed by a wet-on-dry method. For example, the first electrode slurry applied to the electrode current collector 100 may be completely dried, and the second electrode slurry may be applied to the completely dried first electrode slurry. The applied second electrode slurry may be dried and roll-pressed to form the first electrode active material layer 111 and the second electrode active material layer 112.

In one embodiment, the electrode active material layer 110 may be formed by a wet-on-wet method. For example, the second electrode slurry may be applied to the first electrode slurry before the first electrode slurry is completely dried. The first electrode slurry and the second electrode slurry may be dried and roll-pressed simultaneously to form the first electrode active material layer 111 and the second electrode active material layer 112.

For example, the first electrode slurry may include a first electrode active material, a first conductive material, a first binder including a fluorine-based binder, a first solid electrolyte and a solvent.

For example, the second electrode slurry may include a second electrode active material, a second conductive material, a second binder including a hydrocarbon-based binder, a second solid electrolyte and a solvent.

For example, the first and second electrode active materials may include cathode active materials. Examples of the cathode active material may include a lithium iron phosphate compound, a lithium cobalt-based oxide, a lithium manganese-based oxide, a lithium nickel-based oxide, or a lithium composite oxide.

For example, the cathode active material may include a layered compound such as lithium cobalt oxide (LiCoO₂) or lithium nickel oxide (LiNiO₂); or a lithium manganese oxide such as LiMnO₃, LiMn₂O₃ or LiMnO₂; a lithium copper oxide (Li₂CuO₂); a vanadium oxide such as LiV₃O₈, V₂O₅ or Cu₂VO₇; a lithium iron oxide such as LiFe₃O₄, or a lithium iron phosphate oxide such as LiFePO₄.

In one embodiment, the cathode active material may include a compound represented by Formula 2 below.

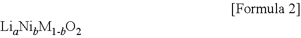

In Formula 2, a and b may satisfy 0.95≤a≤1.08, and b≥0.5, and M may be at least one element of Na, Mg, Ca, Y, Ti, Zr, Hf, V, Nb, Ta, Cr, Mo, W, Mn, Co, Fe, Cu, Ag, Zn, B, Al, Ga, C, Si, Sn, Sr and Ba.

In one embodiment, the cathode active material may further include at least one of cobalt (Co) and manganese (Mn). For example, a nickel-cobalt-manganese (NCM)-based lithium oxide may be used as the cathode active material.

For example, nickel (Ni) may be provided as a metal associated with the capacity of the lithium secondary battery. The higher the content of nickel, the greater the improvement in capacity and output of the lithium secondary battery. However, if the content of nickel increases excessively, it may be disadvantageous in terms of mechanical and electrical stability.

The conductivity or resistance of the lithium secondary battery may be improved by cobalt (Co), and the mechanical and electrical stability of the lithium secondary battery may be improved by manganese (Mn).

The chemical structure represented by Formula 2 shows a bonding relationship between elements included in the lattice structure or crystal structure of the cathode active material, and does not exclude other additional elements. For example, M may be provided as a main active element of the cathode active material. Here, it should be understood that Formula 2 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the crystal structure. The auxiliary element may be incorporated into the crystal structure together to form a bond, and it should be understood that this case is also included within the chemical structure represented by Formula 2.

In some embodiments, the first conductive material and the second conductive material may each include carbon-based conductive materials such as graphite, carbon black, graphene, carbon nanofibers, carbon nanotubes, and/or metal-based conductive materials, including perovskite materials, such as tin, tin oxide, titanium oxide, LaSrCoO₃, or LaSrMnO₃. These may be used alone or in combination of two or more thereof.

In some embodiments, the first conductive material and the second conductive material may be formed of the same type of compound. In some embodiments, the first conductive material and the second conductive material may include different types of compounds.

The first binder may include a fluorine-based polymer, thereby increasing the ionic conductivity of the electrode active material layer 110. The second binder may include a hydrocarbon-based polymer, thereby further improving the dispersibility of the second conductive material in the second electrode active material layer 112.

In one embodiment, during the process of applying and drying the second electrode slurry, a concentration gradient of the binder and/or the conductive material may be formed within each of the first electrode active material layer 111 and the second electrode active material layer 112.

The first solid electrolyte and the second solid electrolyte may each include a sulfide-based electrolyte and/or an oxide-based electrolyte.

The solvent may be, for example, an organic solvent. The organic solvent may include, for example, a tertiary amine-based solvent such as triethylamine; an ester-based solvent such as butyl butyrate; an aromatic solvent such as benzene, toluene, xylene, methoxy benzene, or anisole; a linear aliphatic solvent such as hexane, heptane, octane, nonane, or decane; a cyclic aliphatic solvent such as cycloheptane. These may be used alone or in combination of two or more thereof.

In one embodiment, the methods usable for applying the electrode slurry may include spray coating, dip coating, spin coating, gravure coating, slot die coating, doctor blade coating, roll coating, knife coating, inkjet printing, screen printing, micro contact printing, imprinting, reverse offset printing, bar coating, or gravure offset printing.

According to exemplary embodiments, the first electrode active material layer 111 and the second electrode active material layer 112 may be formed by a transfer process.

For example, a substrate having the second electrode active material layer 112 formed thereon may be transferred onto the first electrode active material layer 111 to form the electrode active material layer 110.

The first electrode slurry may be coated on the electrode current collector 100 to form the first electrode active material layer 111. The second electrode slurry may be coated on a separate transfer substrate to form the second electrode active material layer 112. The above-described application methods may be used as the coating methods for the first electrode slurry and the second electrode slurry.

The transfer substrate may include a film or sheet such as an organic compound or an inorganic compound. For example, the transfer substrate may include an organic sheet such as cellulose, polyethylene, polyester, polypropylene, or polyethylene terephthalate; or an inorganic sheet such as glass fiber, or ceramic.

The transfer substrate having the second electrode active material layer 112 formed thereon may be attached to the first electrode active material layer 111 such that the first electrode active material layer 111 and the second electrode active material layer 112 are in contact with each other. In one embodiment, the first electrode active material layer 111 and the second electrode active material layer 112 may be pressed together.

The transfer substrate may be removed from the second electrode active material layer 112. Since the binder content of the first electrode active material layer 111 is relatively high, transfer defects may be prevented. For example, the adhesion strength between the first electrode active material layer 111 and the second electrode active material layer 112 may be greater than the adhesion strength between the second electrode active material layer 112 and the transfer substrate.

Through the transfer process, electrode active material layers having different compositions may be formed, and the composition and concentration of each electrode active material layer may be readily adjusted. Accordingly, even if the solid content and density increase, a uniform ion or electron conduction network may be formed within the electrode active material layer 110.

Therefore, the electrode active material layer 110 may have a high loading amount of 4.0 mAh/cm² or more without a decrease in ionic conductivity or electronic conductivity, and both the capacity and output characteristics of the lithium secondary battery may be improved.

The lithium secondary battery according to exemplary embodiments may include the above-described electrode for a secondary battery and a counter electrode disposed to face the electrode for a secondary battery.

FIG. 2 is a schematic cross-sectional view illustrating an electrode cell according to exemplary embodiments.

Referring to FIG. 2, the electrode cell may include the electrode for a secondary battery and a counter electrode 200 disposed to face the electrode for a secondary battery. A plurality of the electrode cells may be stacked to form an electrode assembly.

For example, the lithium secondary battery may include a cathode and an anode disposed to face the cathode. One of the cathode and the anode may be the above-described electrode for a secondary battery, and the other may be the counter electrode 200.

The cathode may include a cathode current collector and a cathode active material layer disposed on the cathode current collector. The cathode active material layer may be formed on both surfaces (e.g., upper and lower surfaces) of the cathode current collector.

The anode may include an anode current collector and an anode active material layer disposed on the anode current collector. The anode active material layer may be formed on both surfaces (e.g., upper and lower surfaces) of the anode current collector.

According to exemplary embodiments, the above-described electrode for a secondary battery may be provided as the cathode of a lithium secondary battery.

The cathode current collector may include stainless steel, nickel, aluminum, titanium, copper, or an alloy thereof, and may include, for example, aluminum or an aluminum alloy. In one embodiment, the cathode current collector may also include aluminum or stainless steel having a surface treated with carbon, nickel, titanium or silver.

In one embodiment, the above-described electrode for a secondary battery may be provided as the anode of a lithium secondary battery.

For example, the electrode active material may include an anode active material. The anode active material may include carbon-based materials such as crystalline carbon, amorphous carbon, carbon composites, or carbon fibers; a lithium alloy; silicon or tin; or the like.

Examples of the amorphous carbon may include hard carbon, coke, mesocarbon microbeads (MCMBs) calcined at 1500° C. or lower, mesophase pitch-based carbon fibers (MPCFs) or the like. Examples of the crystalline carbon include graphite carbons such as natural graphite, artificial graphite, graphitized coke, graphitized MCMBs, and graphitized MPCFs. Elements included in the lithium alloy may include aluminum, zinc, bismuth, cadmium, antimony, silicon, lead, tin, gallium, or indium.

The anode current collector may include gold, stainless steel, nickel, aluminum, titanium, copper, or an alloy thereof, and may include copper or a copper alloy, for example. In one embodiment, the anode current collector may include copper having a surface treated with carbon, nickel, titanium, or silver.

Electrode tabs (cathode tabs and anode tabs) may protrude from the cathode current collector and the anode current collector, respectively, and may extend to one side of the case of the secondary battery. The electrode tabs may be fused together with the one side of the case to form electrode leads (a cathode lead and an anode lead) that extend or are exposed to the outside of the case.

According to exemplary embodiments, an electrolyte layer 50 may be interposed between the electrode for a lithium secondary battery and the counter electrode 200. In one embodiment, an electrode cell may be defined by the electrode for a lithium secondary battery, the counter electrode 200, and the electrolyte layer 50. For example, the lithium secondary battery may be provided as an all-solid-state battery.

In some embodiments, the electrolyte layer 50 may be in the form of a film or sheet.

In one embodiment, the electrolyte layer 50 may include a sulfide-based electrolyte and/or an oxide-based electrolyte. In one embodiment, the solid electrolyte included in the electrolyte layer 50 may have the same composition as, or a different composition from, the solid electrolyte included in the electrode active material layer 110.

In one embodiment, the electrolyte layer 50 may include a polymer electrolyte. For example, the polymer electrolyte may include an ionically conductive polymer such as polyethylene oxide (PEO), polypropylene oxide (PPO), polyvinyl alcohol (PVA), polyvinyl pyrrolidone (PVP), or polysiloxane; or a gel polymer electrolyte containing an electrolyte in a polymer matrix.

The polymer electrolyte may further include a lithium salt. The lithium salt may be selected from LiPF₆, LiClO₄, LiBF₄, LiFSI, LiTFSI, LiSO₃CF₃, LiBOB, LiFOB, LiDFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, or a combination thereof.

In one embodiment, a separation membrane may be interposed between the cathode and the anode. The separation membrane may include a porous polymer film made of a polyolefin polymer such as an ethylene homopolymer, a propylene homopolymer, an ethylene/butene copolymer, an ethylene/hexene copolymer, or an ethylene/methacrylate copolymer. The separation membrane may also include a nonwoven fabric made of glass fibers having a high melting point, polyethylene terephthalate fibers or the like.

For example, an electrode cell is defined by the cathode, the anode and the separation membrane, and an electrode assembly may be formed by a plurality of the electrode cells. For example, the electrode assembly may be formed by winding, stacking, or folding the separation membrane.

In one embodiment, the lithium secondary battery may further include a non-aqueous electrolyte that impregnates the cathode and the anode.

The non-aqueous electrolyte may include a lithium salt and an organic solvent. As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, gamma-butyrolactone, propylene sulfite, or tetrahydrofuran may be used. These may be used alone or in combination of two or more thereof.

The electrode assembly may be accommodated in a case to define a lithium secondary battery. The lithium secondary battery may be manufactured in a cylindrical, square, pouch-shaped, or coin-shaped configuration using a can, for example.

Hereinafter, preferable examples are proposed to facilitate understanding of the present disclosure. However, the following examples are only given for illustrating the present disclosure and those skilled in the art will obviously understand that various alterations and modifications are possible within the scope and spirit of the present disclosure. Such alterations and modifications are duly included in the appended claims.

### Fabrication of an Electrode for a Secondary Battery

### Example 1

LiNi_{0.8}Co_{0.1}Mn_{0.1}O₂, a nickel-cobalt-manganese (NCM) oxide as an electrode active material, Li₆PS₅Cl as a solid electrolyte, a fluorine-based rubber as a binder, and carbon black as a conductive material were mixed in an ester-based organic solvent in the weight ratio of 80:17.5:1:1.5 to prepare a first electrode slurry.

The first electrode slurry was uniformly applied to a carbon-coated aluminum foil having a thickness of 18 μm, and vacuum-dried at 80° C. for 24 hours to form a first electrode slurry coating layer (hereinafter, also abbreviated as a first laminate).

LiNi_{0.8}Co_{0.1}Mn_{0.1}O₂, a nickel-cobalt-manganese (NCM) oxide as an electrode active material, Li₆PS₅Cl as a solid electrolyte, a butadiene-based rubber as a binder, and carbon black as a conductive material were mixed in an ester-based organic solvent in the weight ratio shown in Table 1 below to prepare a second electrode slurry.

The second electrode slurry was applied to a transfer substrate (PET film) and vacuum-dried at 80° C. for 24 hours to form a second electrode slurry coating layer (hereinafter, also abbreviated as a second laminate).

The first and second electrode slurry coating layers were stacked in a direction in which the coating layers faced each other, and then the first and second laminates were roll-pressed at 270 MPa.

Thereafter, the transfer substrate attached to the second laminate was removed, and a cathode including an aluminum foil and a first cathode active material layer and a second cathode active material layer that were sequentially stacked on one surface of the aluminum foil was fabricated.

In the fabricated cathode, the loading amount of the cathode active material layer formed by the first and second cathode active material layers was 4.0 mAh/cm².

### Example 2

A cathode was fabricated in the same manner as in Example 1, except that the electrode active material, the solid electrolyte, the binder, and the conductive material were mixed in the weight ratio shown in Table 1 below when manufacturing the first electrode slurry and the second electrode slurry.

In the fabricated cathode, the loading amount of the cathode active material layer formed by the first and second cathode active material layers was 4.0 mAh/cm².

### Comparative Example 1

LiNi_{0.8}Co_{0.1}Mn_{0.1}O₂, a nickel-cobalt-manganese (NCM) oxide as an electrode active material, Li₆PS₅Cl as a solid electrolyte, a fluorine-based rubber as a binder, and carbon black as a conductive material were mixed in an ester-based organic solvent in the weight ratio shown in Table 1 below to prepare an electrode slurry.

The electrode slurry was uniformly applied to a carbon-coated aluminum foil having a thickness of 18 μm, vacuum-dried at 80° C. for 24 hours, and roll-pressed at 270 MPa to fabricate a cathode including a single cathode active material layer.

In the fabricated cathode, the loading amount of the cathode active material layer was 4.0 mAh/cm².

### Comparative Example 2

LiNi_{0.8}Co_{0.1}Mn_{0.1}O₂, a nickel-cobalt-manganese (NCM) oxide as an electrode active material, Li₆PS₅Cl as a solid electrolyte, a butadiene-based rubber as a binder, and carbon black as a conductive material were mixed in an ester-based organic solvent in the weight ratio shown in Table 1 below to prepare an electrode slurry.

The electrode slurry was uniformly applied to a carbon-coated aluminum foil having a thickness of 18 μm, vacuum-dried at 80° C. for 24 hours, and roll-pressed at 270 MPa to fabricate a cathode including a single cathode active material layer.

In the fabricated cathode, the loading amount of the cathode active material layer was 4.0 mAh/cm².

TABLE 1

| | | | | Comparative | Comparative |
|---|---|---|---|---|---|
| Classification | | Example 1 | Example 2 | Example 1 | Example 2 |
| First | Electrode active material | 80 | 80 | 80 | 80 |
| electrode | Solid electrolyte | 17.5 | 17.5 | 17.5 | 17.5 |
| active | Binder | Fluorine- | Fluorine- | Fluorine- | Butadiene- |
| material layer | | based | based | based | based |
| (wt %) | | rubber | rubber | rubber | rubber |
| | | 1 | 1 | 1 | 1 |
| | Conductive material | 1.5 | 1.5 | 1.5 | 1.5 |
| Second | Electrode active material | 80 | 80 | | |
| electrode | Solid electrolyte | 17.5 | 17.5 | | |
| active | Binder | Butadiene- | Butadiene- | — | — |
| material layer | | based | based | | |
| (wt %) | | rubber | rubber | | |
| | | 0.9 | 0.7 | | |
| | Conductive material | 1.6 | 1.8 | | |
| Concentration | Binder concentration ratio | 0.9 | 0.7 | | |
| ratio | Conductive material concentration ratio | 1.07 | 1.2 | | |

In Table 1, the binder concentration ratio denotes the ratio of the content of the second binder in the second electrode active material layer to the content of the first binder in the first electrode active material layer, and the conductive material concentration ratio denotes the ratio of the content of the second conductive material in the second electrode active material layer to the content of the first conductive material in the first electrode active material layer.

### Manufacture of a Lithium Secondary Battery

A lithium secondary battery was manufactured as follows using each of the cathodes fabricated in the above-described examples and comparative examples.

A solid electrolyte (Li₆PS₅Cl) was placed in a SUS circular mold having a diameter of Φ10 at a predetermined density and was press-molded at 150 MPa to fabricate a solid electrolyte pellet.

The cathode was placed on one surface of the solid electrolyte pellet and was pressed at 370 MPa to form an integrated pellet. Then, a lithium-indium foil was placed on the other surface and was pressed at 100 MPa to manufacture a lithium secondary battery in the form of a pressed cell having a structure including the cathode, the solid electrolyte and the anode.

### Experimental Example: Evaluation of Rate Characteristics

The discharge capacity was measured under the following conditions using a charge/discharge tester (WBCS3000, Won-A Tech Co., Ltd.) for each lithium secondary battery manufactured in the above-described examples and comparative examples.

Charging (CC-CV, 3.65V cut-off) and discharging (CC, 1.88V cut-off) were performed on the lithium secondary battery at approximately 30° C., and this was defined as one cycle.

Three cycles of charging and discharging were performed on the lithium secondary battery at a C-rate of 0.1C, and the discharge capacity in the third cycle was measured.

Three cycles of charging and discharging were performed on the lithium secondary battery at a C-rate of 1.0C, and the discharge capacity in the third cycle was measured.

Three cycles of charging and discharging were performed on the lithium secondary battery at a C-rate of 2.0C, and the discharge capacity in the third cycle was measured.

The percentage (%) of the discharge capacity in the third cycle at a C-rate of 1.0C relative to the discharge capacity in the third cycle at a C-rate of 0.1C, and the percentage (%) of the discharge capacity in the third cycle at a C-rate of 2.0C relative to the discharge capacity in the third cycle at a C-rate of 0.1C were evaluated as the rate characteristics.

The results are shown in Table 2 below.

TABLE 2

| | 1.0 C/0.1 C | 2.0 C/0.1 C |
|---|---|---|
| | Rate characteristics (%) | Rate characteristics (%) |
| Example 1 | 82.5 | 67.4 |
| Example 2 | 83.0 | 69.2 |
| Comparative Example 1 | 81.2 | 62.9 |
| Comparative Example 2 | 81.9 | 60.8 |

From Table 2, the lithium secondary batteries manufactured in Examples 1 and 2 exhibited a higher capacity retention as the charge and discharge rates increased.

The lithium secondary batteries manufactured in Comparative Examples 1 and 2 were evaluated to exhibit a lower capacity retention as the charge and discharge rates increased.

### DESCRIPTION OF REFERENCE NUMERALS

50: Electrolyte layer
100: Electrode current collector
110: Electrode active material layer
111: First electrode active material layer
112: Second electrode active material layer
200: Counter electrode

What is claimed is:

1. An electrode for a secondary battery comprising:
an electrode current collector,
a first electrode active material layer disposed on the electrode current collector, and comprising a first electrode active material, a first conductive material, a first binder including a fluorine-based binder and a first solid electrolyte; and
a second electrode active material layer disposed on the first electrode active material layer, and comprising a second electrode active material, a second conductive material, a second binder including a hydrocarbon-based binder and a second solid electrolyte.

2. The electrode for a secondary battery according to claim 1, wherein the fluorine-based binder comprises at least one of a vinylidene fluoride-based polymer and a vinylidene fluoride-hexafluoropropylene copolymer.

3. The electrode for a secondary battery according to claim 1, wherein the hydrocarbon-based binder comprises a butadiene-based rubber.

4. The electrode for a secondary battery according to claim 1, wherein the hydrocarbon-based binder has a non-aromatic structure.

5. The electrode for a secondary battery according to claim 1, wherein the content of the first binder in the first electrode active material layer and the content of the second binder in the second electrode active material layer differ from each other.

6. The electrode for a secondary battery according to claim 5, wherein the content of the first binder in the first electrode active material layer is greater than that of the second binder in the second electrode active material layer.

7. The electrode for a secondary battery according to claim 6, wherein a ratio of the content of the second binder in the second electrode active material layer to the content of the first binder in the first electrode active material layer is 0.1 or more and less than 1.

8. The electrode for a secondary battery according to claim 6, wherein the content of the first binder is greater than 0.1 wt % and less than or equal to 20 wt % based on the total weight of the first electrode active material layer, and
the content of the second binder is 0.1 wt % to 10 wt % based on the total weight of the second electrode active material layer.

9. The electrode for a secondary battery according to claim 1, wherein the content of the first conductive material in the first electrode active material layer and the content of the second conductive material in the second electrode active material layer differ from each other.

10. The electrode for a secondary battery according to claim 9, wherein the content of the second conductive material in the second electrode active material layer is greater than that of the first conductive material in the first electrode active material layer.

11. The electrode for a secondary battery according to claim 10, wherein the ratio of the content of the second conductive material in the second electrode active material layer to the content of the first conductive material in the first electrode active material layer is greater than 1 and less than or equal to 5.

12. The electrode for a secondary battery according to claim 10, wherein the content of the first conductive material is 0.1 wt % to 10 wt % based on the total weight of the first electrode active material layer, and
the content of the second conductive material is more than 0.1 wt % and less than 20 wt % based on the total weight of the second electrode active material layer.

13. The electrode for a secondary battery according to claim 1, wherein the ratio of the content of the second solid electrolyte in the second electrode active material layer to the content of the first solid electrolyte in the first electrode active material layer is 0.1 to 1.0.

14. The electrode for a secondary battery according to claim 1, wherein the first solid electrolyte and the second solid electrolyte each comprise a sulfide-based electrolyte.

15. The electrode for a secondary battery according to claim 1, wherein the ratio of the content of the second electrode active material in the second electrode active material layer to the content of the first electrode active material in the first electrode active material layer is 0.95 to 1.05.

16. A secondary battery comprising:
the electrode for a secondary battery according to claim 1;
a counter electrode disposed to face the electrode for a secondary battery; and
an electrolyte layer interposed between the electrode for a secondary battery and the counter electrode.

17. The secondary battery according to claim 16, wherein the electrolyte layer comprises a solid electrolyte.

18. The secondary battery according to claim 16, wherein the secondary battery is provided as an all-solid-state battery.
